(19) United States
(12) Patent Application Publication
(10) Pub. No.: US 2014/0096151 A1
(43) Pub. Date: Apr. 3, 2014

(54) OPTICAL DISK DRIVE WITH STORAGE DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-HAO YANG, New Taipei (TW); XIANG-KUN ZENG, Shenzhen (CN); ER-WEI LU, Shenzhen (CN); ZHI-QIANG ZUO, Shenzhen (CN)

(21) Appl. No.: 13/925,773

(22) Filed: Jun. 24, 2013

(30) Foreign Application Priority Data
Sep. 28, 2012 (CN) 2012103670006

(51) Int. Cl. G11B 17/04

(52) U.S. Cl. CPC G11B 17/04
USPC 720/601

(57) ABSTRACT

An optical disk drive includes a disk drive body and a storage device. The drive body includes a receiving bracket and a support tray received in the receiving bracket. The support tray is used for supporting a disk. The support tray includes a tray body. The tray body defines an inserting slot. The storage device includes a main body and an inserting head connected to the main body. The inserting head is received in the inserting slot. The optical disk drive has a storage device which can be used by people to copy data.

### BACKGROUND

1. Technical Field

The present disclosure relates to disk drives, and more particularly relates to an optical disk drive with a storage device.

2. Description of Related Art

A conventional computer includes a hard disk drive. People may copy data from the hard disk drive via the mobile storage device, such USB flash disk. Sometimes, people want to copy data while they take no storage device with them, which is inconvenient.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an optical disk drive in accordance with one embodiment of the present disclosure.

FIG. 2 is an isometric view of a storage device of FIG. 1.

FIG. 3 is similar to FIG. 2, an inserting head and two positioning protrusions of the storage device unfolded.

FIG. 4 is an isometric view of the storage device mounted to the support tray of FIG. 1.

FIG. 5 is an assembled view of the optical disk drive of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

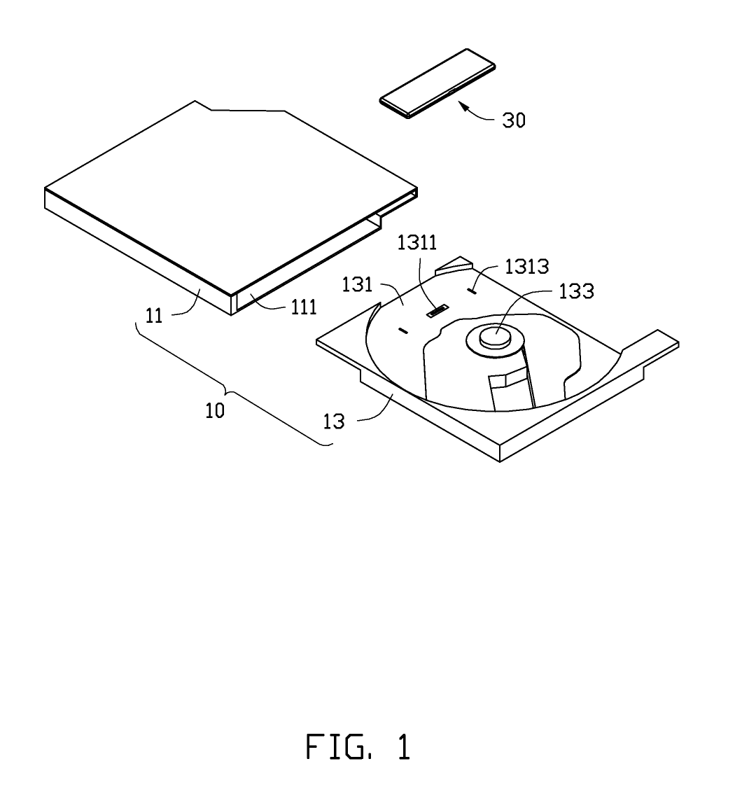

FIG. 1 shows an optical disk drive of the embodiment. The optical disc drive includes a disk drive body 10 and a storage disk drive 30. In one embodiment, the storage disk drive 30 is a solid-state drive or a flash memory.

The disk drive body 10 includes a receiving bracket 11 and a support tray 13. The receiving bracket 11 defines a receiving space 111. The support tray 13 is received in the receiving space 111. The support tray 13 includes a tray body 131 and a mounting protrusion 133 extending from the tray body 131. The mounting protrusion 133 is used for being received in a mounting opening of a disk (not shown). The tray body 131 defines an inserting slot 1311 and two positioning holes 1313. The inserting slot 1311 is located between the two positioning holes 1313. An extending direction of the inserting slot 1311 is substantially perpendicular to the extending direction of the positioning hole 1313. The inserting slot 1311 is capable of being electrically connected to a printed circuit board of a computer.

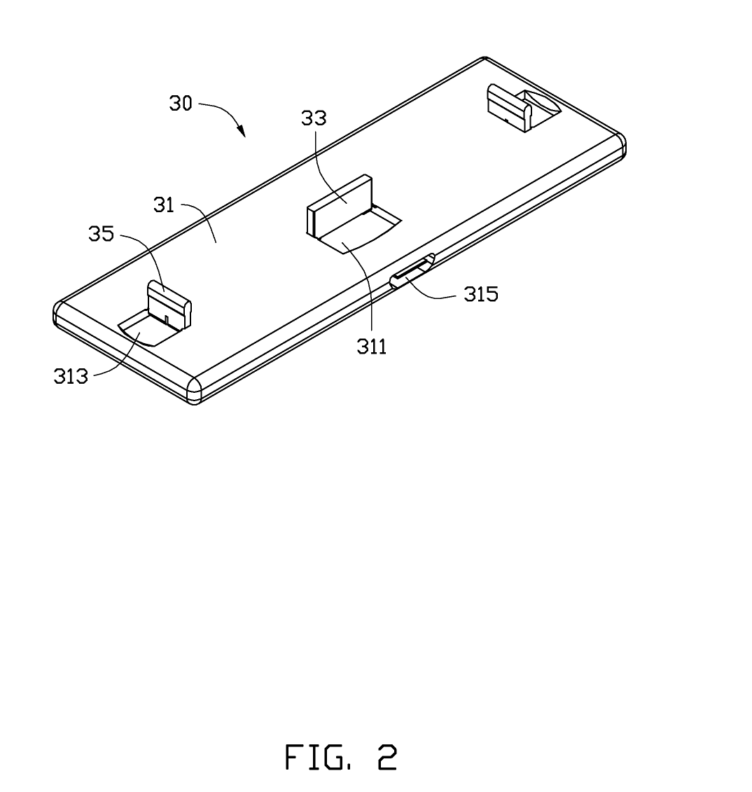

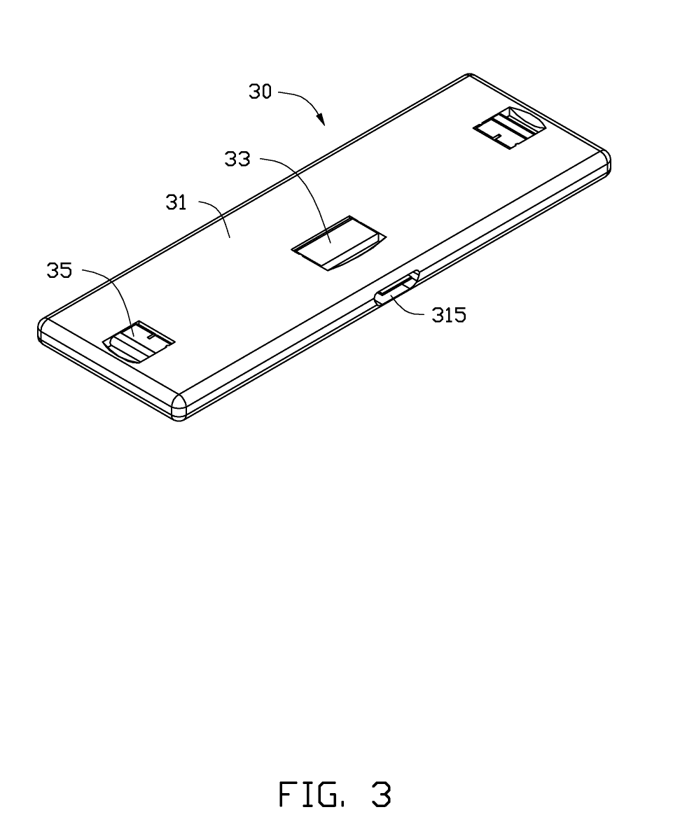

FIGS. 2 and 3 shows that the storage device 30 includes a main body 31, an inserting head 33, and two positioning protrusions 35. The main body 31 is rectangular and is substantially parallel to the tray body 131. The main body 31 defines a first notch 311 corresponding to the inserting head 33 and two second notches 313 corresponding to the two positioning protrusions 35. The inserting head 33 is pivotally mounted in the first notch 311 and is capable of rotating to be received in the first notch 311. The two positioning protrusions 35 are pivotally mounted in the two second notches 313 and are capable of rotating to be received in the second notches 313. The main body 31 further defines an interface 315 for being connected to other electronic device. The extending direction of the interface 315 is substantially parallel to the tray body 131. In one embodiment, the interface 315 is a mini USB interface.

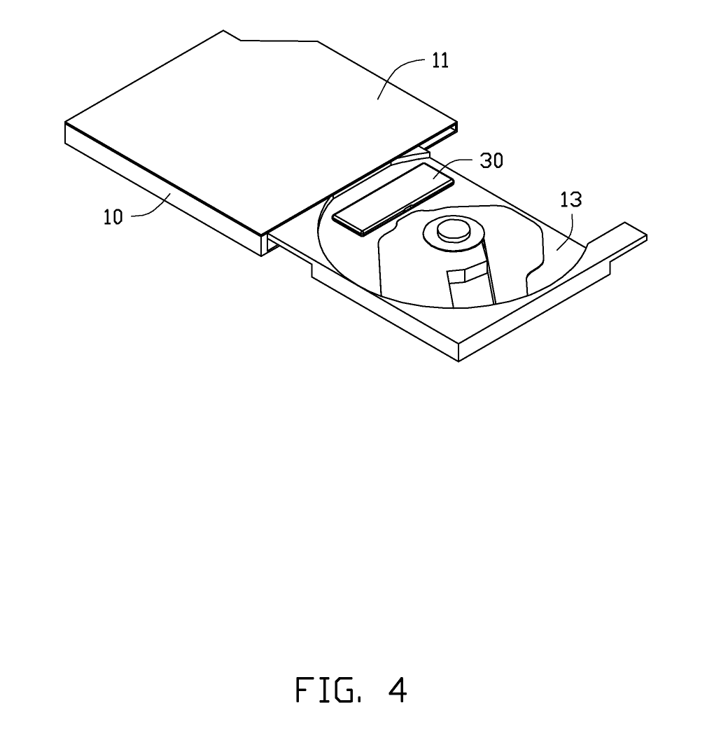

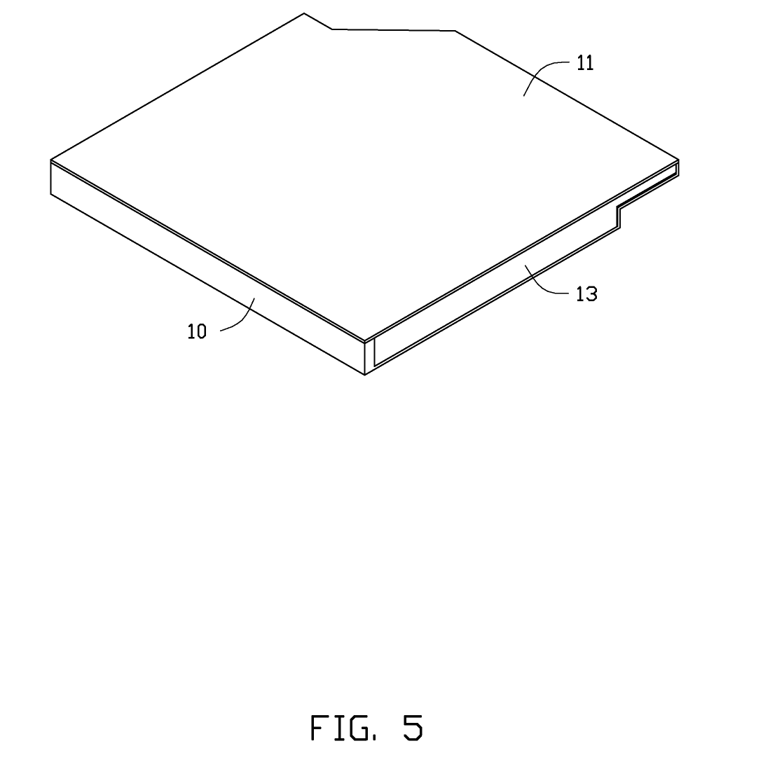

FIGS. 1 to 5 show that in assembly, the inserting head 33 of the storage device 30 and the positioning protrusions 35 rotate to a position to be substantially perpendicular to the main body 31. The inserting head 33 and the positioning protrusions 35 are aligned with the inserting slot 1311 and the two positioning holes 1313. The storage device 30 moves down, along a first direction substantially perpendicular to the tray body 131, to enable the inserting head 33 to be inserted into the inserting slot 1311 and the two positioning protrusions 35 to be inserted into the positioning holes 1313, thereby being secured to the support tray 13. The support tray 13 is aligned with the receiving space 111 of the receiving bracket 11. The support tray 13 moves towards the receiving bracket 11, along a second direction substantially perpendicular to the first direction, to be received in the receiving space 111.

In disassembly, the storage device 30 moves up to be disengaged from the disk drive body 10, and users can copy data from a computer via the storage device 30.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An optical disk drive, comprising:
a disk drive body, the disk drive body comprises a receiving bracket and a support tray received in the receiving bracket; the support tray is configured to support a disk; the support tray comprises a tray body; and the tray body defines an inserting slot; and
a storage device; the storage device comprises a main body and an inserting head connected to the main body, and the inserting head is configured to be received in the inserting slot.

2. The optical disk drive of claim 1, wherein the storage device further comprises a positioning protrusion extending from the main body, and the tray body defines a positioning hole for receiving the positioning protrusion.

3. The optical disk drive of claim 2, wherein the positioning protrusion is pivoted to the main body.

4. The optical disk drive of claim 3, wherein the main body defines a notch, and the positioning protrusion is pivotally mounted in the notch.

5. The optical disk drive of claim 2, wherein an extending direction of the inserting slot is substantially perpendicular to an extending direction of the positioning hole.

6. The optical disk drive of claim 1, wherein the inserting head is pivotally mounted to the main body.

7. The optical disk drive of claim 6, wherein the main body defines a notch, and the inserting head is pivotally mounted in the notch.

8. The optical disk drive of claim 1, wherein the main body is rectangular and the main body is substantially parallel to the tray body.

9. The optical disk drive of claim 1, wherein the storage device further comprises two positioning protrusions connected to the main body; the inserting head is located between the two positioning protrusions; and the tray body defines two positioning holes for receiving the two positioning protrusions.

10. The optical disk drive of claim 1, wherein the main body defines an interface for being electrically connected to an electronic device.

11. An optical disk drive, comprising:
a disk drive body, the disk drive body comprises a receiving bracket and a support tray; the support tray comprises a tray body and a mounting protrusion for mounting a disk; the receiving bracket defines a receiving space; the support tray is configured to be received in the receiving space, along a first direction that is substantially parallel to the tray body; and the tray body defines an inserting slot; and
a storage device; the storage device comprises a main body and an inserting head connected to the main body, and the inserting head is configured to be received in the inserting slot along a second direction that is substantially perpendicular to the first direction.

12. The optical disk drive of claim 11, wherein the storage device further comprises a positioning protrusion extending from the main body, and the tray body defines a positioning hole for receiving the positioning protrusion.

13. The optical disk drive of claim 12, wherein the positioning protrusion is pivoted to the main body.

14. The optical disk drive of claim 13, wherein the main body defines a notch, and the positioning protrusion is pivotally mounted in the notch.

15. The optical disk drive of claim 12, wherein an extending direction of the inserting slot is substantially perpendicular to an extending direction of the positioning hole.

16. The optical disk drive of claim 11, wherein the inserting head is pivotally mounted to the main body.

17. The optical disk drive of claim 16, wherein the main body defines a notch, and the inserting head is pivotally mounted in the notch.

18. The optical disk drive of claim 11, wherein the main body is rectangular and the main body is substantially parallel to the tray body.

19. The optical disk drive of claim 11, wherein the storage device further comprises two positioning protrusions connected to the main body; the inserting head is located between the two positioning protrusions; and the tray body defines two positioning holes for receiving the two positioning protrusions.

20. The optical disk drive of claim 11, wherein the main body defines an interface for being electrically connected to an electronic device.
